(19) United States
(12) Patent Application Publication
(10) Pub. No.: US 2022/0120859 A1
(43) Pub. Date: Apr. 21, 2022

(54) SPHERICALLY MOUNTED RETROREFLECTOR WITH TITANIUM INSERT

(71) Applicant: MetrologyWorks, Inc., Buckner, MO (US)

(72) Inventors: Eric S. Becker, Spirit Lake, IA (US); Joel R. Gorden, Grain Valley, MO (US)

(21) Appl. No.: 17/507,784

(22) Filed: Oct. 21, 2021

Related U.S. Application Data
(60) Provisional application No. 63/094,845, filed on Oct. 21, 2020.

(51) Int. Cl. G01S 7/481; G01S 17/42

(52) U.S. Cl. CPC G01S 7/481; G01B 11/005; G01S 17/42

(57) ABSTRACT

A spherically mounted retroreflector (SMR) includes a spherical body and an optical insert made of titanium to provide increased performance and lighter weight. The increased strength of titanium allows an optical insert with a smaller geometry that uses less material. The use of titanium for an optical insert also allow the thickness between the cavity of the body and the insert to vary. Titanium is lighter weight than SS which is more ergonomic for an operator. This is important for larger sizes of SMRs, such as approximately 1.5 to 3 inches in diameter.

### CROSS REFERENCE TO RELATED APPLICATIONS

The present application claims priority to Provisional Patent Application U.S. Ser. No. 63/094,845 filed Oct. 21, 2020 and titled “Spherically Mounted Retroreflector with Titanium Insert,” herein incorporated by reference.

### BACKGROUND

A laser tracker system is a precision 3D coordinate measuring machine that is used to measure physical objects such as machine components with measurements to very high accuracies. Spherically mounted retroreflectors (SMRs) are important components of laser tracker systems. The precision and centering of associated SMRs contribute to the overall repeatability and accuracy of the laser tracker system as well as to the accuracy and repeatability of measurements that the system will be capable of capturing.

An SMR generally includes an optic device such as a retroreflector mounted inside a spherical rigid ball. A retroreflector employs three orthogonal planar reflective surfaces or mirrors meeting at an apex, with the retroreflector mounted so that the apex is coincident with the center of the ball. A laser beam emitted of a constant wavelength by a robotic laser tracker head is reflected by the three mirrors back to the robotic laser tracker head. The laser tracker measures the distance the laser beam has traveled by analyzing the shift in the phase the laser emitted to the return beam reflected by the SMR. The shift in phase is used to measure an XYZ point that is dependent on the laser tracker's two rotary axis encoder positions (angles) and the reflected laser ranging distance to the SMR.

The angle between any two mirrors of the three orthogonal planar reflective surfaces of an SMR is called a dihedral angle. For accurate measurement and tracking by the laser tracker, the dihedral angles are precisely controlled. A dihedral angle is usually required to be 8.5 arc seconds or less depending on size of the retro-reflector, with SMRs intended for longer range use having dihedral angles as low as 1 arcsecond or lower. The overall accuracy of a laser tracker system, which may be at or below 0.001 inches at 10 meters distance, depends on the combination of its internal scales and sensors that detect two angles and the one ranging distance and the SMR. Accuracy is important if a radial offset is being used based on optic centering in the ball.

The laser tracker takes a measurement at the apex of the optic which is located as close as possible to the precise center of the SMR ball. When used with a laser tracker to take measurements, the diameter of the SMR ball is a parameter given to 3D measurement capture and analysis software, where is it used to compensate with a radial offset from the center of the ball.

The diameter and sphericity (roundness) of an SMR ball naturally affect the offset accuracy of measurements performed by a laser tracker, therefore these features of an SMR are critical and SMRs must be precise in these characteristics. Moreover, the actual centering of the optic within an SMR has a significant influence on the accuracy of a laser tracker system. The more accurately an optic can be centered in an SMR ball body the less error it will contribute to measurements, thereby contributing to the overall accuracy of the laser tracker system. However, operating temperature changes may cause the apex position to change as materials in the SMR expand and contract, whether do to internal geometry of the SMR or contrasting coefficients of thermal expansion (CTEs).

### SUMMARY OF THE EMBODIMENTS

In a first aspect, an SMR includes a spherical body and an optical insert made of titanium to provide increased performance and lighter weight. Additionally, the increased strength of titanium allows an optical insert with a smaller geometry that uses less material. The use of titanium for an optical insert also allow the thickness between the cavity of the body and the insert to vary. Titanium is lighter weight than SS which is more ergonomic for an operator. This is important for larger sizes of SMRs, such as approximately 1.5 to 3 inches in diameter.

### BRIEF DESCRIPTION OF THE FIGURES

FIG. 1A depicts an exploded view of an SMR, in embodiments.

FIG. 1B depicts a cross-sectional view of the SMR of FIG. 1A, in embodiments

FIG. 2A depicts an exploded view of an SMR with a modified optical insert, in embodiments.

FIG. 2B depicts a cross-sectional view of the SMR of FIG. 2A, in embodiments.

FIG. 3A depicts an exploded view of an SMR with a titanium optical insert, in embodiments.

FIG. 3B depicts a cross-sectional view of the SMR of FIG. 3A, in embodiments.

FIG. 4 illustrates an optical insert used in an SMR that has become distorted at an extreme temperature, in embodiments.

FIG. 5 is a flowchart illustrating a method of fabricating an SMR with a titanium insert, in embodiments.

### DETAILED DESCRIPTION OF THE EMBODIMENTS

A spherically mounted retroreflector (SMR) is used with a laser tracker to take precision measurements in a manufacturing and/or testing environment. A retroreflector optic having three orthogonal planar reflective surfaces or mirrors meeting at an apex is mounted inside a spherical rigid ball so that the apex of the optic which is coincident with the precise center of the SMR ball. Balls used to make SMRs have may be made of stainless steel such as 420 or 440C or non-magnetic ceramics such as alumina or zirconia, for example, although any material capable of forming a rigid, spherical shape may be used.

The diameter and sphericity (roundness) of an SMR ball naturally affects the offset accuracy of measurements performed by a laser tracker, therefore these features of an SMR are critical and SMRs must be precise in these characteristics. Moreover, the actual centering of the optic within an SMR has a significant influence on the accuracy of a laser tracker system. The more accurately an optic can be centered in an SMR ball body the less error it will contribute to measurements, thereby contributing to the overall accuracy of the laser tracker system.

Using poorly centered SMRs results in correspondingly inaccurate measurements with a laser tracker system. Often in applications for laser trackers multiple individual point measurements are required to establish a reference system and then multiple single point measurements or features are measured to document the dimensional characteristics of a part or system. For example, calculating the location of the centroid and orientation of a plane requires measuring at least 3 individual point measurements. If the measured plane represents a face on a large machine this would require the operator to take 3 points with an SMR on face of the machine. Each point taken requires an offset for the radius of the SMR since the point captured by the laser tracker is taken at the center of the apex of the optic. If, for example, the optic was poorly centered in the ball such that its apex was 0.001″ radially from the center of the ball and this SMR was used in the exact same orientation for all three measurements with the maximum SMR centering offset along the +X axis, then the machine location of the centroid of Plane 1 would be calculated to be shifted 0.001″ in the +X direction from the ball center. If the orientation of the SMR was then changed to be 180 degrees opposite and used to perform the same set of 3 measurements, the centroid of the plane would be shifted in the −X direction by 0.001″ from the ball center. Thus, a calculation of the distance from the centroid of Plane 1 to Plane 2 would have a 0.002″ difference even though the same plane was measured with the same system twice. This shows that the centering error can be compounded with multiple measurements. Even small errors in the centricity of SMR optics can result in significant measurement errors when used for repeat or multiple readings and when used in conjunction with other features and point measurements.

Accordingly, precisely centered SMR optics are advantageous for high-precision applications. SMRs typically come with a centering certificate that provides maximum reference displacement values for X and Y (which are sometimes combined to represent a runout value) and Z which usually represents the depth of the optic in the ball from the center point along the axis of the optic, with respect to the center of the SMR to enable a user to estimate the precision with which the overall laser tracker system can be used to measure physical objects.

SMRs may be manufactured in a single solid piece, where the retroreflector is machined out of a ball, or in multiple pieces where the retroreflector is manufactured separately then installed in a cavity in the ball. Both styles have costs and benefits.

Several factors must be considered in multipart SMRs. The relative CTEs of the ball and the optic must be considered and the impact of different CTEs during extreme temperatures must be considered. Retaining the optic inside the ball may require an adhesive which can further complicate CTE considerations because these methods depend on the cure time/rate of the glue or epoxy. They also require that the manufacturer make assumptions about X, Y and Z axis positions during assembly and wait for the glue to cure to find out how much any of these values changed during cure of the adhesive, which can be significant depending on the amount of adhesive used, shrink rate, temperature, humidity and other factors. Industry tolerance standards for centering are very precise and commonly range from 0.0005″ to 0.0001″ meaning that precision assembly is critical and extremely difficult to achieve. Accordingly, relying on chance for the actual precision of the assembly meant that a majority of SMRs manufactured in this way are not very precisely centered which leads to lower yield and increased costs.

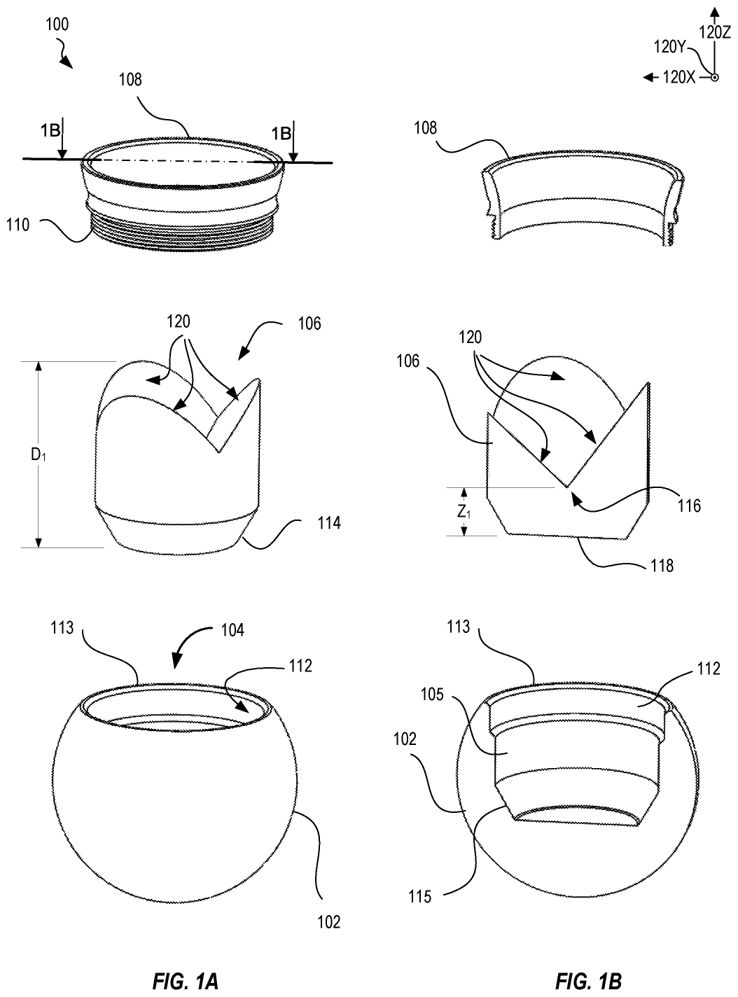

In embodiments, FIG. 1A shows an exploded view of an SMR 100 and FIG. 1B shows the exploded SMR of FIG. 1A in a cross-sectional view. FIGS. 1A and 1B are best viewed together in the following description. The cross-section illustrated in FIG. 1B is parallel to a plane, hereinafter the x-z plane, formed by orthogonal axes 120X and 120Z, which are each orthogonal to an axis 120Y. The cross-sectional view of FIG. 1B is through a center of SMR 100. Unless otherwise specified, heights and depths discussed herein refer to the object's extent along axis 120Z. Displacements discussed herein refer to displacement values along axes 120X and 120Y.

SMR 100 includes a body 102 with a generally spherical outer surface and having a sphere center at a point equidistant from all points on the surface of body 102. A cavity 104 is formed in body 102 having a rim 113 at the surface of body 102, cylinder 105 and a chamfer 115. In embodiments, body 102 may be made from a ferromagnetic material. Optical insert 106 may be rigidly fixed in cavity 104, which may be formed by a machining process to have an inner profile that complements the outer profile of optical insert 106. Optical insert 106 has an inner surface formed of three orthogonal planes 120 meeting at apex 116 and forming a corner-cube retroreflector. Optical insert 106 has a generally cylindrical outer surface culminating in chamfer 114. Optical insert 106 has a depth D₁. In embodiments, cavity 104 and optical insert 106 have geometries that cooperate to position apex 116 coincident with center of body 102 so as to provide precision performance as described above.

In embodiments, protective ring 108 may be affixed to body 102 to protect optical insert 106 from impact, block some of the light coming into SMR 100 and also provide a user with a surface to manually grip or to allow for the attachment of a lanyard or cord to prevent dropping SMR 100. For purposes of illustration, a protective ring 108 having a given shape and configuration is shown in FIGS. 1A and 1B however, other shapes and configurations are possible without departing from the principles disclosed here. In some embodiments, SMR 100 may not include protective ring 108.

In embodiments, protective ring 108 may include threads 110 for attachment to body 102 at threaded surface 112 around a rim of cavity 104. Protective ring may be, for example, aluminum, stainless steel, titanium or other metal or plastic material. In various embodiments, the material is aluminum, which can be anodized and dyed to a color which is selected to represent a centering accuracy classification or to designate a particular series or brand.

As shown in FIGS. 1A and 1B, optical insert 106 includes a chamfer 114. It is complemented by chamfer 115 in cavity 104. Chamfers 114 and 115 have the advantage of preserving the sphericity of body 102 because the less material that is removed from an SMR body blank when forming cavity 104, the more the roundness and consistency of the SMR ball body 102 will be preserved.

In embodiments, an adhesive material is applied only to cavity 104 before inserting optical insert 106. In embodiments including protective ring 108, a thread locking substance may be applied to the threads of the protective ring 108 or the receiving threaded surface 112, which once cured would also function to retain optical insert 106 in the ball.

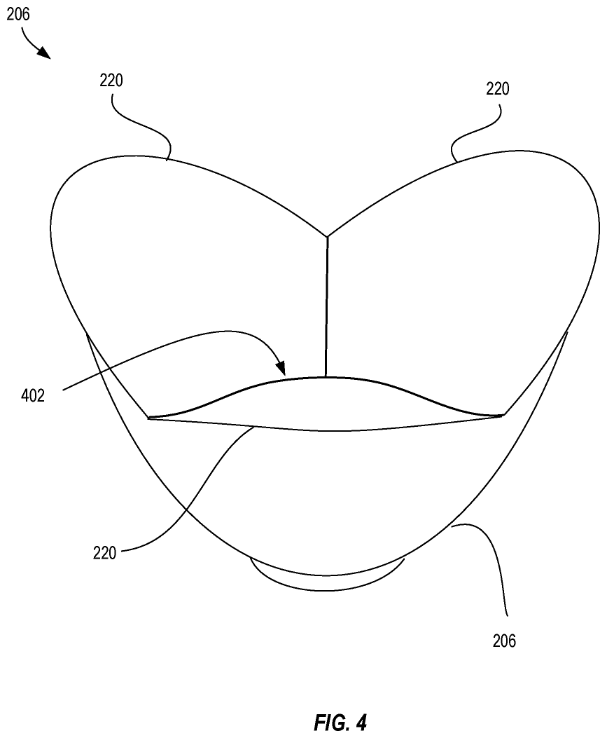

As shown particularly in FIG. 1B, optical insert 106 includes a substantial quantity of material between apex 116 and its lower surface 118, as indicated by Z₁. Depending on the material used for optical insert 106, it may be vulnerable to CTE (coefficient of thermal expansion) issues at certain temperatures after it is inserted into body 102. This will be discussed below in connection with FIG. 4.

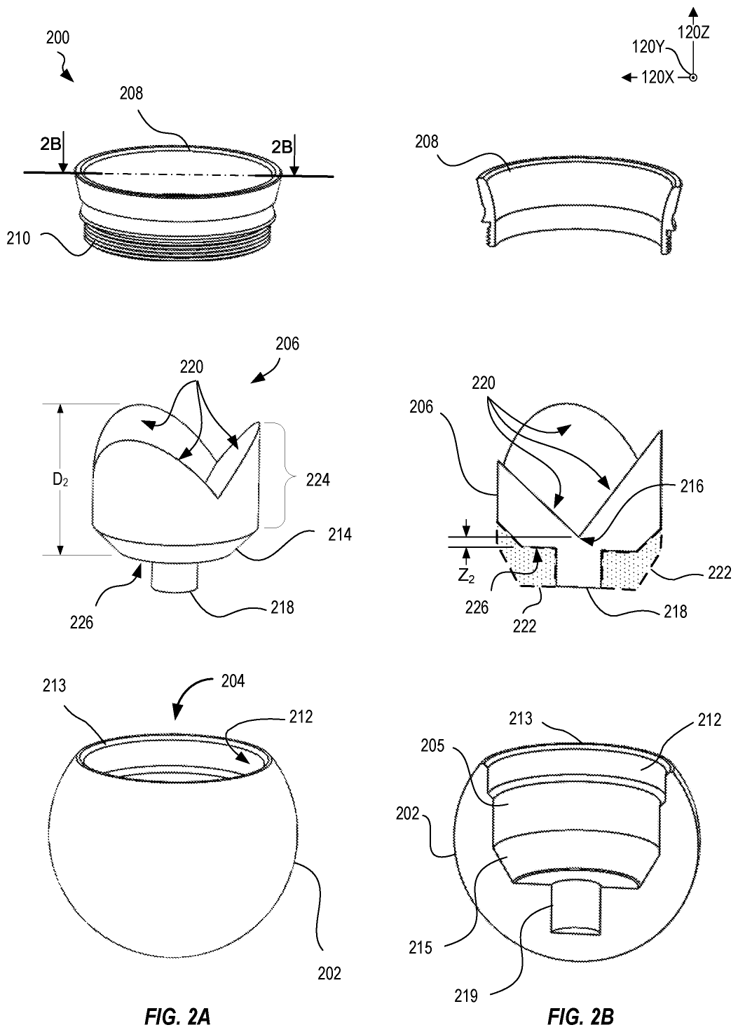

FIGS. 2A and 2B.FIG. 2A shows an exploded view of an SMR 200 and FIG. 2B shows SMR 200 in a cross-sectional view, in embodiments. SMR 200 is oriented with respect to orthogonal axes 120X, 120Y and 120Z as described above for FIGS. 1A and 1B. FIGS. 2A and 2B are best viewed together in the following description.

SMR 200 includes a body 202 with a generally spherical outer surface and having a sphere center at a point equidistant from all points on the surface of body 202. A cavity 204 is formed in body 202 having a rim 213 at the surface of body 202, cylinder 205 and a chamfer 215. A mounting cavity 219 extends from the bottom of cavity 204. In embodiments, cavity 204 may also include threaded surface 212 for attaching protective ring 208 as described below.

Optical insert 206 has an inner surface of three orthogonal surfaces 220 meeting at apex 216 and forming a corner-cube retroreflector, similarly to optical insert 106 of FIGS. 1A and 1B. Optical insert 206 has a generally cylindrical outer surface with an upper portion 224, a chamfer 214 and base 226. Optical insert 206 has a depth D₂ that is smaller than D₁ of FIG. 1A. In addition, optical insert 206 includes a mounting stud 218 extending along axis 120Z from base 226. Mounting stud 218 nests in corresponding mounting cavity 219 in cavity 204. Mounting stud 218 and mounting cavity 219 have smaller diameters than upper portion 224 of optical insert 206 and rim 213 of cavity 204, respectively. When optical insert 206 is inserted into body 202, chamfer 214 of optical insert 206 nests in chamfer 215 of cavity 204.

In embodiments, protective ring 208 is affixed to body 202 to protect optical insert 206 from impact, block some of the light coming into SMR 200 and also provide a user with a surface to manually grip or to allow for the attachment of a lanyard or cord to prevent dropping SMR 200. For purposes of illustration, a protective ring 208 having a given configuration is shown in FIGS. 2A and 2B however, other configurations are possible without departing from the principles disclosed here. In some embodiments, SMR 200 may not include protective ring 208. Protective ring 208 may include threads 210 for attachment to body 202 in threaded surface 212 around the rim of cavity 204. Protective ring may be, for example, aluminum, stainless steel, titanium or other metal or plastic material. In various embodiments, the material is aluminum, which can be anodized and dyed to a color which is selected to represent a centering accuracy classification or to designate a particular series or brand.

Optical insert 206 may be rigidly fixed in cavity 204, which may be formed by a machining process to have an inner profile that complements the outer profile of optical insert 206. An adhesive material may be used to securely attach optical insert 206 in cavity 204. When inserting optical insert 206 into body 202, apex 216 is coincident with the sphere center of body 202. In embodiments, adhesive is applied to one or both of mounting stud 218 and mounting cavity 219. In some embodiments, a potting material may be used in addition to or instead of an adhesive material.

In embodiments, optical insert 106 or 206 may be made out of various metals including aluminum, steel, stainless steel, tungsten etc. It may also be made of plastic such as injection molded plastic polymers, ceramics or other similar material as long as the material is capable of being made to be reflective in the three orthogonal directions. In various embodiments, the insert is made from an EDM manufactured corner-cube upon which a reflective material optical surface is adhered through a process called replication. In various embodiments this is an optically coated layer of vapor deposited gold, silver, aluminum or other similar material. In various embodiments, this layer is augmented by a protective or enhancing overcoat.

A comparison of FIGS. 1B and 2B shows that the quantity of material contained in optical insert 206 is far less than that of optical insert 106 indicated by Z₁ as illustrated in FIG. 2B as shaded areas 222 which show the portion of optical insert 106 that is not present in optical insert 206. The reduced quantity of material in optical insert 206 means that CTE issues are less of a problem when the operating temperature changes. However, depending on the material used for optical insert 206, providing structural strength for orthogonal surfaces 220 still requires a substantial amount of material. Applying adhesive only to mounting stud 218 and/or mounting cavity 219 further minimizes distortion caused by different CTEs of the materials used in SMR 200.

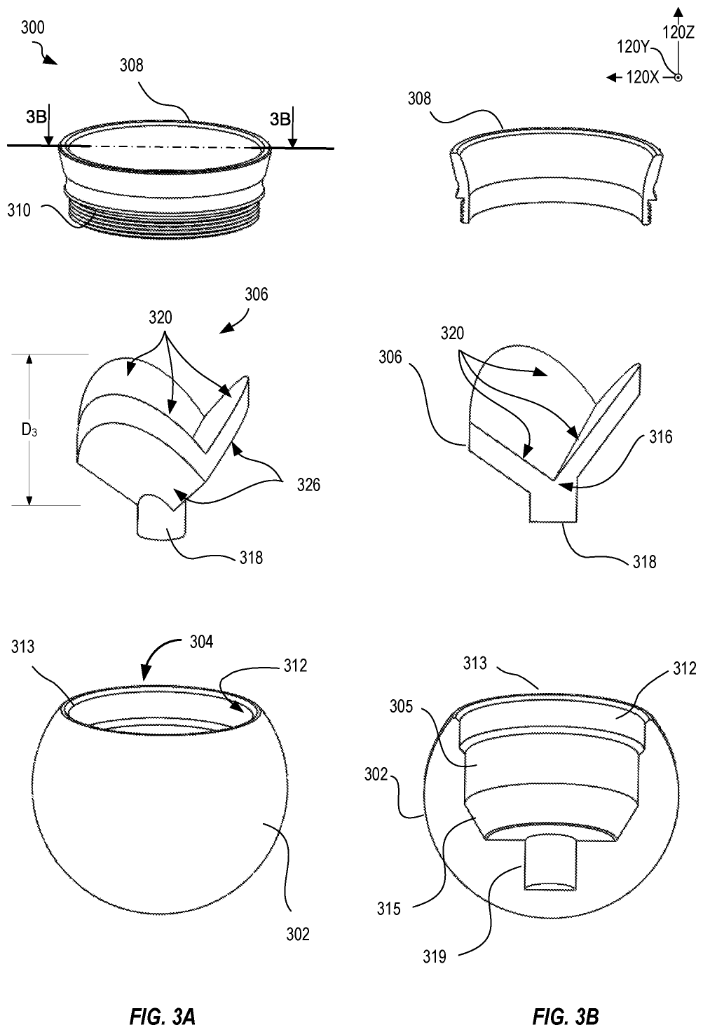

A modified optical insert that uses even less material than optical insert 206 while still providing structural strength is shown in FIGS. 3A and 3B.

FIG. 3A shows an exploded view of an SMR 300 and FIG. 3B shows SMR 300 in a cross-sectional view, in embodiments. FIGS. 3A and 3B are best viewed together in the following description. SMR 200 is oriented with respect to orthogonal axes 120X, 120Y and 120Z as described above for FIGS. 1A and 1B.

SMR 300 includes a body 302 with a generally spherical outer surface and having a sphere center at a point equidistant from all points on the surface of body 302. A cavity 304 is formed in body 302 having a rim 313 at the surface of body 302, a cylinder 305 with a rim 313. A mounting cavity 319 extends from the bottom of cavity 304. In embodiments, cavity 304 may also include threaded surface 312 for attaching protective ring 308 as described below.

Optical insert 306 has an inner surface of three orthogonal surfaces 320 meeting at apex 316 and forming a corner-cube retroreflector, similarly to optical insert 206 of FIGS. 2A and 2B. The outer surfaces 326 of optical insert 306 generally circumscribe a cylinder. The inner and outer surfaces of optical insert 306 form plates that have a generally uniform material thickness. Optical insert 306 has a depth D₃ that is smaller than D₁ of FIG. 1A. In addition, optical insert 306 includes a mounting stud 318 which nests in corresponding mounting cavity 319 in cavity 304. Mounting stud 318 and mounting cavity 319 have smaller diameters than the upper portion optical insert 306 and rim 313 of cavity 304, respectively.

As shown in FIG. 3B, cavity 304 has a profile similar to that of cavity 204 in FIG. 2B. In embodiments, optical insert 306 may be used with this cavity, or with a smaller cavity (not shown) with a profile that is the inverse of optical insert 306. For SMR 300, using the smaller titanium optical insert 306 with a larger cavity 304 as shown further reduces the weight of SMR 300 while maintaining structural integrity of both optical insert 306 and body 302. Structural integrity of body 302 means that it remains spherical. There is a limit on how large cavity 304 may be without making body 302 vulnerable to deforming when dropped, for example. With an aluminum optical insert as shown in FIGS. 2A-2B, a large optical insert 206 is necessary so cavity 204 is as small as possible while still accommodating optical insert 206. With the titanium optical insert 306 of FIG. 3B, SMR 300 may use this small titanium insert which is lightweight in combination with a larger cavity 304 in body 302 to further decrease the weight of SMR 300. In embodiments, any open space between optical insert 306 and cavity 304 may or may not be filled with an adhesive or potting material.

Protective ring 308 is affixed to body 302 to protect optical insert 306 from impact, block some of the light coming into SMR 300 and also provide a user with a surface to manually grip or to allow for the attachment of a lanyard or cord to prevent dropping SMR 300. Protective ring 308 may include threads 310 for attachment to body 302 in threaded surface 312 around the rim of cavity 304. Protective ring may be, for example, aluminum, stainless steel, titanium or other metal or plastic material. In various embodiments, the material is aluminum, which can be anodized and dyed to a color which is selected to represent a centering accuracy classification or to designate a particular series or brand.

In embodiments, any of optical inserts 106, 206 and 306 may be made of titanium to provide increased performance. For an optical insert made of aluminum, with a CTE of 13.1 ppm/Degree F., the disparity with a stainless-steel body having a much lower CTE means that SMRs with aluminum optical inserts are prone to distortion at high and low temperatures. In general, the orthogonal surfaces of the insert start to deflect as the material of the insert shrinks or grows and this causes the angles between the faces to change (sometimes enough to make the laser tracker unable to actually measure and tracker the insert). If the angles between the orthogonal surfaces are more than approximately 8-12 arc seconds it starts to become difficult to track at any significant distance over approximately 50 ft, depending on which laser tracker is used.

Reducing the amount of material used for the optical insert as shown in FIGS. 2A and 2B provides improved performance over optical insert 106 of FIGS. 1A-1B. An aluminum insert with this design may be able to provide accurate measurements between approximately 55° F. and 85° F. However, it may be necessary to use a laser tracker system in conditions outside of this temperature range. An optical insert made of titanium (for instance 6AL-4V), which has a CTE of 4.78 ppm/Degree F. may provide an increased operational temperature range.

An optical insert 206 of FIGS. 2A and 2B may be made of a variety of materials as described herein however, the use of titanium provides increased performance and lighter weight. In embodiments, a titanium alloy of Grade 5-6Al-4V may be used. Additionally, the increased strength of titanium allows an optical insert as shown in FIGS. 3A and 3B, which has a smaller profile. Titanium is lighter weight than stainless steel which is more ergonomic for an operator. This is important for larger sizes of SMRs, such as approximately 1.5 to 4 inches in diameter. For reference a typical Aluminum insert similar to optical insert 206 in FIG. 2A may have a volume of approximately 0.38 Cubic inches. A titanium optical insert 306 of FIG. 3A may have an approximate volume of 0.15 Cubic inches.

A comparison of FIGS. 2B and 3B shows that the quantity of material contained in the optical insert 306 is measurably less than that of optical insert 206 due to the thinner profiles used for orthogonal surfaces 320. As shown in FIG. 3B, cavity 304 has a profile similar to that of cavity 204 in FIG. 2B. In embodiments, optical insert 306 may be used with this cavity, or a smaller cavity with a profile similar to optical insert 306 may be used. For SMR 300, using the smaller titanium optical insert 306 with a larger profile cavity further reduces the weight of SMR 300 while maintaining structure integrity of both optical insert 306 and body 302. Structural integrity of body 302 means that it remains spherical. There is a limit on how large cavity 304 may be without making body 302 vulnerable to deforming when dropped, for example. With an aluminum optical insert as shown in FIGS. 2A-2B, a large optical insert 206 is necessary so cavity 204 is as small as possible while still accommodating optical insert 206. With the titanium optical insert 306 of FIG. 3B, SMR 300 may use this small titanium insert which is lightweight in combination with a larger cavity 304 in body 302 to further decrease the weight of SMR 300. In embodiments, any open space between optical insert 306 and cavity 304 may or may not be filled with an adhesive or potting material.

In any of the above embodiments, body 102, 202, 302 may be made from a ferromagnetic material such as 420 or 440C stainless steel, which has a CTE of approximately 5.6 ppm/Degree F. A stainless-steel body is used for tooling setups that use magnets to hold the SMR in position. A ceramic material such as Alumina or Zirconia may also be used for certain applications that benefit from either non-magnetic property and/or having excellent wear characteristics when used on cast steel or tooling plate materials, for example. The CTE of a ceramic material is much lower than that of stainless steel.

In any of the above embodiments, optical insert 106, 206 or 306 may be made with a variety of materials as listed above. An optical insert made of aluminum provides advantages in terms of cost and machinability, however, with a CTE of 13.1 ppm/Degree F., the disparity with the CTE of stainless steel means that SMRs with aluminum optical inserts are prone to distortion at high and low temperatures. In general, the orthogonal surfaces of the insert start to deflect as the material of the insert shrinks or grows and this causes the angles between the faces to change (sometimes enough to make the laser tracker unable to actually measure and track the insert). If the angles between the orthogonal surfaces are more than approximately 8-12 arc seconds it starts to become difficult to track at any significant distance over approximately 50 ft, depending on which laser tracker is used.

Reducing the amount of material used for the optical insert as shown in FIGS. 2A and 2B provides improved performance over optical insert 106 of FIGS. 1A-1B. An aluminum insert with this design may be able to provide accurate measurements between approximately 55° F. and 85° F. However, it may be necessary to use a laser tracker system in conditions outside of this temperature range. An optical insert made of titanium (for instance 6AL-4V), which has a CTE of 4.78 ppm/Degree F. may provide an increased operational temperature range.

In embodiments, an SMR with a diameter of approximately 3 to 4 inches may use a body with a matte finish in applications using a laser tracker in combination with a large-scale 3D scanner. Large scale 3D scanners can scan a sphere at a distance and use software to fit a center point. The SMR typically needs to be 3.5-4 inches in diameter to be practical. If the SMR is much smaller, it cannot be placed very far from the scanner as there needs to be a minimum number of points on the sphere to fit it accurately to find the center. A 4 inch SMR with a SS insert or a larger Aluminum insert would be very heavy and in some cases even dangerous at elevated heights.

Along with being lightweight, titanium has a very high strength to weight ratio which could allow even smaller inserts (in terms of the total volume of material used) while retaining good strength and thermal stability, especially compared to aluminum.

FIG. 4 illustrates an optical insert used in an SMR that has become distorted when used at an extreme temperature. In embodiments, FIG. 4 depicts optical insert 206 of FIGS. 2A-2B, but principles discussed below apply to any of the SMRs disclosed herein. FIG. 4 depicts optical insert 206 at an elevated temperature 125 Degrees F. where the OD at the bottom 20% and the bottom are constrained by adhesive. Because of the difference in CTE, between the optical insert 206 and body 202 (not shown), orthogonal surfaces 220 have started to expand, or buckle, as shown at 402. Expanding material 402 cannot go out or down so it pushes up in the center of optical insert 206 causing distortion of the insert. A reduction in expansion and less material as provided by the embodiments disclosed herein will minimize this distortion.

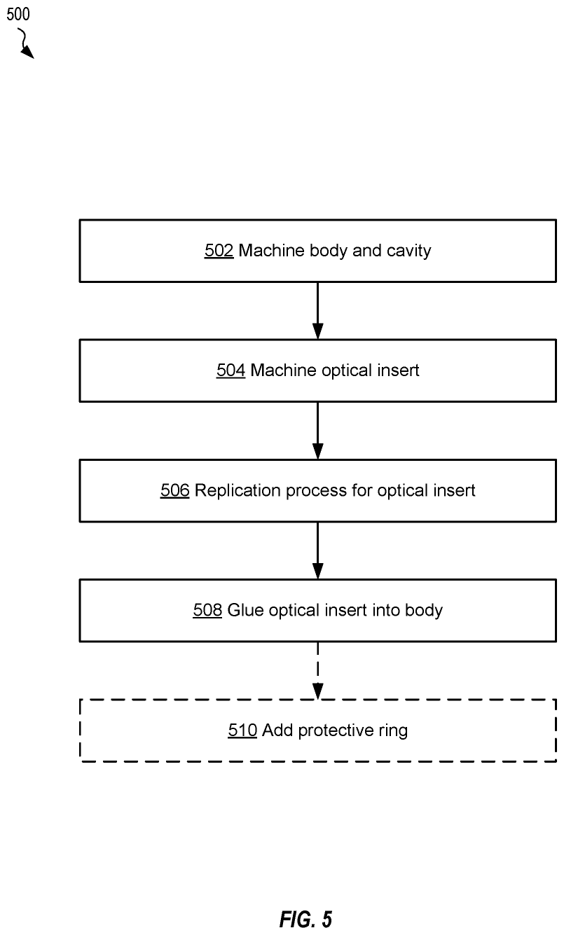

FIG. 5 is a flowchart illustrating a method 500 for fabricating an SMR with a titanium insert. Although a sequence of steps are shown, some steps may be done simultaneously or in a different order. In embodiments, method 500 includes steps 502-508. In some embodiments, method 500 also includes step 510.

In step 502, an SMR body is machined. In an example of step 502, a generally spherical ball such as body 202 or 302 is machined from stainless steel 440C and cavity 204, 304 with threaded surface 212 or 312 is machined in the body.

In step 504, an optical insert is machined. In an example of step 504, optical insert 206, 306 is machined to have a selected backside geometry and a cavity formed from three 90-degree orthogonal surface 220, 320 forming a retroreflector cube.

In step 506, the optical insert goes through an optical epoxy replication process. In an example of step 506, a reflective metal such as Gold is evaporated on a high precision master, epoxy is applied to the retroreflector cavity of optical insert 206, 306 and then the high precision master is pressed into the optical insert. Once cured the master is separated and the optical surface in the insert retains the properties of the master.

In step 508, the optical insert is glued into the body. In an example of step 508, optical insert 206, 306 is glued into body 202, 302 and centered using either optical or mechanical centering means. For example, X and Y adjustments to the position of optical insert 206, 306 may be made in any available high-precision manner by applying force to the outside of the insert or insert assembly. For example, manual high precision set screws or more automated rod or rail linear actuators or encoded stepper motors in connection with threaded adjustment screws may be used. In an embodiment, high precision manual set screws are used to set the X and Y position of the optical insert 206, 306 before the adhesive material becomes rigid.

In optional step 510, a protective ring is added to the SMR. In an example of step 510, protective ring 208, 308 is threaded into threaded surface 212, 312 of body 202, 302 to protect optical insert 206, 306 from being hit or damages during use. In addition, a Z-axis position of optical insert 206, 306 may be adjusted by tightening or loosening protecting ring 208, 308 before the adhesive material from step 508 becomes rigid.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A spherically mounted retroreflector (SMR), comprising:
a ferromagnetic body having a spherical outer surface having a sphere center and a cavity extending towards the sphere center from the spherical outer surface and having a first diameter; and
an optical insert made from titanium comprising an inner surface defining a corner-cube retroreflector having an apex coincident with the sphere center.

2. The SMR of claim 1, further comprising a protective ring attached to a rim of the cavity.

3. The SMR of claim 2, wherein the protective ring further comprises threads for engaging with a threaded surface on the rim of the cavity.

4. The SMR of claim 1, wherein the ferromagnetic body further comprises a mounting cavity extending from the base of the cavity and having a second diameter smaller than the first diameter.

5. The SMR of claim 4, wherein the optical insert further comprises a mounting stud configured to be inserted in the mounting cavity.

6. The SMR of claim 1, wherein the body further comprises a body chamfer at a base of the cavity and the optical insert further comprises an optical insert chamfer that nests into the body chamfer.

7. The SMR of claim 1, wherein the optical insert further comprises an outer surface the forms a uniform material thickness with the inner surface.

8. The SMR of claim 7, wherein the optical insert has a smaller volume than the cavity.

9. A method of making a spherically mounted retroreflector (SMR), comprising:
machining a body from a ferromagnetic material, said body comprising a spherical outer surface having a sphere center and a cavity extending towards the sphere center from the spherical outer surface and having a first diameter;
machining an optical insert from titanium, said optical insert comprising an inner surface defining a corner-cube retroreflector having an apex coincident with the sphere center; and
securing the optical insert into the cavity in the body using an adhesive.

10. The method of claim 9, further comprising threading a protective ring into the cavity to secure the optical insert within the cavity.

11. The method of claim 9, wherein machining the body further comprises machining the body from 440C stainless steel.

12. The method of claim 9, further comprising performing a replication process on the optical insert to form the corner-cube retroreflector.

13. The method of claim 9, wherein the body further comprises a mounting cavity extending from the base of the cavity and having a second diameter smaller than the first diameter.

14. The method of claim 13, wherein the optical insert further comprises a mounting stud configured to be inserted in the mounting cavity.

15. The method of claim 14, wherein securing the optical insert further comprises applying the adhesive to the mounting cavity or the mounting stud.
